(19) United States
(12) Patent Application Publication
(10) Pub. No.: US 2020/0117167 A1
(43) Pub. Date: Apr. 16, 2020

(54) CONTROL SYSTEM OF MACHINE TOOL

(71) Applicant: FANUC CORPORATION, Yamanashi (JP)

(72) Inventor: Hang CUI, Yamanashi (JP)

(73) Assignee: FANUC CORPORATION, Yamanashi (JP)

(21) Appl. No.: 16/597,150

(22) Filed: Oct. 9, 2019

(30) Foreign Application Priority Data
Oct. 11, 2018 (JP) 2018-192661

(51) Int. Cl. G05B 19/409; G05B 19/414; G05B 19/402

(52) U.S. Cl. CPC G05B 19/409; G05B 19/4145; G05B 2219/32074; G05B 2219/31265; G05B 19/402

(57) ABSTRACT

An object is to provide a control system of a machine tool which can efficiently return the set state of parameters for CNC to a previous set state. A storage unit which stores parameter change history data and parameter attribute data and a change history organization unit which uses the parameter change history data and the parameter attribute data to organize parameters for each of change history attributes and which thereby generates a change history attribute unit list are included. Moreover, a change history display unit which displays the change history attribute unit list, a Undo/Redo target selection unit which specifies arbitrary parameters in the change history attribute unit list obtained by organizing the parameters for each of the change history attributes and a parameter setting return processing unit which performs return processing for returning to the parameters specified in the Undo/Redo target selection unit are included.

This application based on and claims the benefit of priority from Japanese Patent Application No. 2018-192661, filed on 11 Oct. 2018, the content of which is incorporated herein by reference.

### BACKGROUND OF THE INVENTION

### Field of the Invention

The present invention relates to a control system of a machine tool.

### Related Art

As is known, in the field of machine tools, a CNC (Computerized Numerical Control) technology is applied, the amount of movement of a tool, the speed of movement thereof and the like are numerically controlled with a computer and thus the repetition of the same machining procedure, the machining of a complicated shape and the like are highly automated. Data produced with a CAD or a CAM is captured into the CNC, and furthermore, various types of data such as an option, parameters, an NC program, a microprogram, a macro variable, a workpiece origin offset, a tool offset, tool shape data and tool management data are input and controlled, with the result that an NC machine tool such as an NC lathe or a machining center is consistently automated from design to manufacturing (see, for example, patent document 1).

Patent Document 1: Japanese Unexamined Patent Application, Publication No. 2003-202910

### SUMMARY OF THE INVENTION

On the other hand, when parameters for the CNC are changed, the set state of previous parameters and parameters after being changed are compared, and thus the effectiveness of the parameters after being changed is verified. The verification of the effectiveness of the parameters for the CNC after the setting thereof is changed is performed by storing (recording) the previous parameters and inputting the parameters again or using the mechanism of Undo & Redo. The mechanism of Undo & Redo is a mechanism in which the past settings are taken out chronologically (Undo) and in which the setting on the current side is returned from the past setting (Redo).

However, as described above, the mechanism of Undo & Redo is configured such that the Undo/Redo is performed chronologically. Hence, when the current parameters are returned to parameters obtained by returning a plurality of times (parameters obtained by returning a plurality of times are taken out), as shown in FIG. 10, it is necessary to individually repeat the operation of Undo a number of times corresponding to the number of times a plurality of changes are made. In other words, in order to perform an operation returning to the state of previous parameters, it is disadvantageously necessary to take a large amount of effort, labor and time.

In view of the foregoing conditions, an object of the present invention is to provide a control system of a machine tool which can efficiently return the set state of parameters for CNC to a previous set state.

The present inventors et al. find a method by which the set state of parameters for CNC can be efficiently returned to a previous set state so as to complete the present invention. More specifically, the present invention provides the followings.

(1) In the present invention, a control system of a machine tool which is automated by reflecting parameters with computerized numerical control includes: a storage unit which stores change history data of parameters and attribute data of the parameters; and a change history organization unit which organizes, with the parameter change history data and the parameter attribute data, the parameters for each of change history attributes so as to generate a change history attribute unit list.

(2) Preferably, in the present invention, in (1) described above, the control system of the machine tool includes: a Undo/Redo target selection unit which specifies arbitrary parameters in the change history attribute unit list; and a parameter setting return processing unit which performs return processing for returning to the parameters specified in the Undo/Redo target selection unit.

(3) Preferably, in the present invention, in (1) and (2) described above, the control system of the machine tool includes a change history display unit which displays the change history attribute unit list.

(4) Preferably, in the present invention, in any one of (1) to (3) described above, the change history organization unit includes: a change history acquisition unit which acquires the parameter change history data from the storage unit; a change history organization request acquisition unit which receives a change history organization request; a parameter attribute acquisition unit which acquires the parameter attribute data from the storage unit; an attribute list generation unit which uses the parameter change history data and the parameter attribute data so as to generate an attribute list of the parameters; and a change history attribute unit list generation unit which organizes the attribute list for each of the change history attributes so as to generate the change history attribute unit list.

(5) Preferably, in the present invention, in (4) described above, when in the attribute list, a history in which one parameter is changed a plurality of times is present, a plurality of parameters having the same attribute are treated as one set such that the parameter setting return processing unit returns the parameters for each unit of a set state of the parameters.

According to the present invention, it is possible to efficiently return the set state of parameters for CNC to a previous set state.

Specifically, it is possible to organize a change history arranged chronologically and to return, in one stroke, to desired parameters, and thus as compared with a conventional one, is possible to significantly reduce the effort, the labor and the time of an operator when the setting of parameters for CNC is changed.

### BRIEF DESCRIPTION OF THE DRAWINGS

FIG. 1 is a block diagram showing a control system of machine tool according to an embodiment of the present invention;

FIG. 2 is a block diagram showing a change history organization unit in the control system of the machine tool according to the embodiment of the present invention;

FIG. 3 is a diagram showing an example of an attribute list/change history list and a change history attribute unit list in the control system of the machine tool according to the embodiment of the present invention;

FIG. 4 is a diagram showing a flow for generating the attribute list/change history list and the change history attribute unit list with the control system of the machine tool according to the embodiment of the present invention;

FIG. 5 is a diagram showing the flow for generating the attribute list/change history list and the change history attribute unit list with the control system of the machine tool according to the embodiment of the present invention;

FIG. 6 is a diagram showing the flow for generating the attribute list/change history list and the change history attribute unit list with the control system of the machine tool according to the embodiment of the present invention;

FIG. 7 is a diagram showing an example of the attribute list/change history list and the change history attribute unit list (a function history parameter list and a state list) in the control system of the machine tool according to the embodiment of the present invention;

FIG. 8 is a diagram showing a flow for generating the attribute list/change history list and the change history attribute unit list (the function history parameter list and the state list) with the control system of the machine tool according to the embodiment of the present invention;

FIG. 9 is a diagram showing the flow for generating the attribute list/change history list and the change history attribute unit list (the function history parameter list and the state list) with the control system of the machine tool according to the embodiment of the present invention; and

FIG. 10 is a diagram showing a case where a conventional control system of a machine tool is used so as to perform Undo processing on parameters.

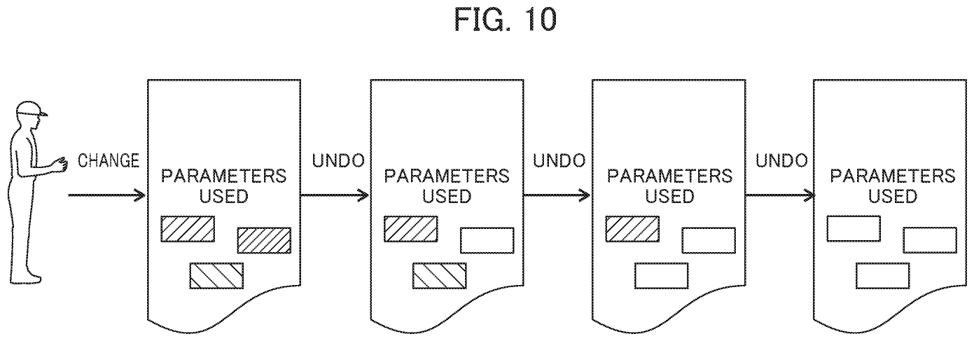

### DETAILED DESCRIPTION OF THE INVENTION

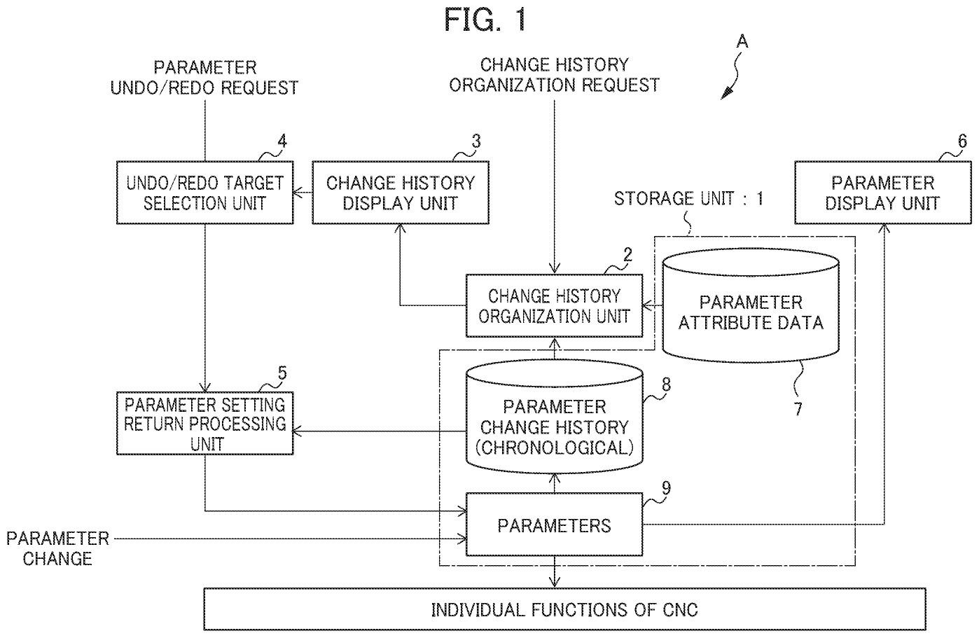

A control system of a machine tool according to an embodiment of the present invention will be described below with reference to FIGS. 1 to 9.

The control system A of the machine tool in the present embodiment configured so as to reflect various types of data such as an option, parameters, an NC program, a microprogram, a macro variable, a workpiece origin offset, tool offset, tool shape data and tool management data on the side of the machine tool (CNC: computerized numerical control) such as an NC lathe or a machining center and to thereby automate a machining operation. The control system. A of the machine tool is also configured with a computer which includes a memory such as a ROM (read only memory) and a RAM (random access memory), CPU (control processing unit) and a communication control unit that are connected together through a bus. Examples of the parameter include various types of parameters on, for example, the control of the machine tool such as an angle of inclination of an inclination axis on the control of the inclination axis and the axis number of the inclination axis.

The control system A of the machine tool in the present embodiment further includes, as shown in FIG. 1, a storage unit 1, a change history organization unit 2, change history display unit 3, an Undo/Redo target selection unit 4, a parameter setting return processing unit 5 and a parameter display unit 6.

The storage unit 1 stores, for example, data (parameter attribute data) 7 of various types of attributes of the parameters such as the functional attributes of the control of the inclination axis, the synchronization control of a feed axis and the like and the systematic attributes of the machine tool, chronological parameter change history data 8 and parameters 9 used in the machine tool.

The change history organization unit 2 a unit which organizes, according to a change history organization request, various types of data stored in the storage unit 1.

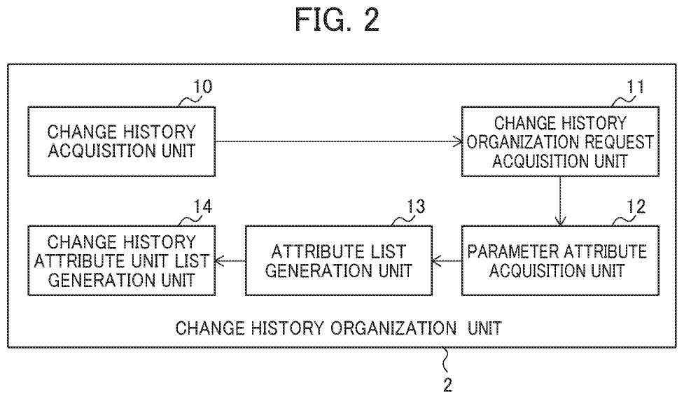

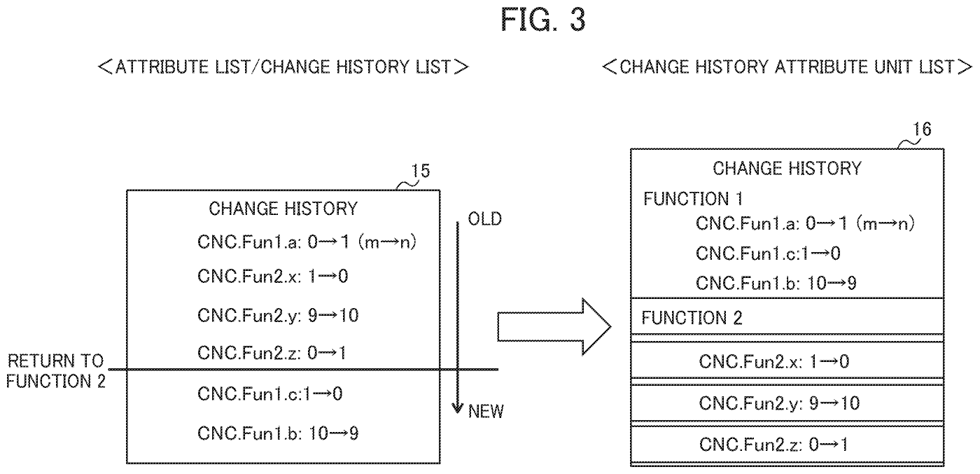

As shown in FIG. 2, the change history organization unit of the present embodiment includes: a change history acquisition unit 10 which acquires the parameter change history data 8 from the storage unit 1; a change history organization request acquisition unit 11 which receives (acquires, detects) the change history organization request; a parameter attribute acquisition unit 12 which acquires the parameter attribute data 7 from the storage unit 1; an attribute list generation unit 13 which generates an attribute list 15 (see a diagram on the left side of FIG. 3) of the parameters; and a change history attribute unit list generation unit 14 which organizes the attribute list 15 for each change history attribute so as to generate a change history attribute unit list 16 (see a diagram on the right side of FIG. 3). In the present embodiment, a “function” shown in the diagram on the right side of FIG. 3 and the like indicates, for example, the control of the inclination axis or the synchronization control of the feed axis.

The change history display unit 3 displays the change history attribute unit list 16 which is generated in the change history attribute unit list generation unit 14.

The Undo/Redo target selection unit 4 is a unit which receives an Undo/Redo request for the parameters so as to select, from the change history attribute unit list 16 generated in the change history attribute unit list generation unit 14 and displayed in the change history display unit 3, a target on which to perform Undo or Redo.

The parameter setting return processing unit 5 is a unit for changing (return set) the setting of the parameters to parameters, such as previous (past) parameters, which are arbitrarily selected in the Undo/Redo target selection unit 4.

The parameter display unit 6 displays parameters used in the control of the machine tool.

Then, a method and a procedure of using the control system A of the machine tool configured as described above and according to the present embodiment so as to return, in one stroke, to previous desired parameters (parameters set in the past) such as parameters obtained by returning a plurality of times will be described.

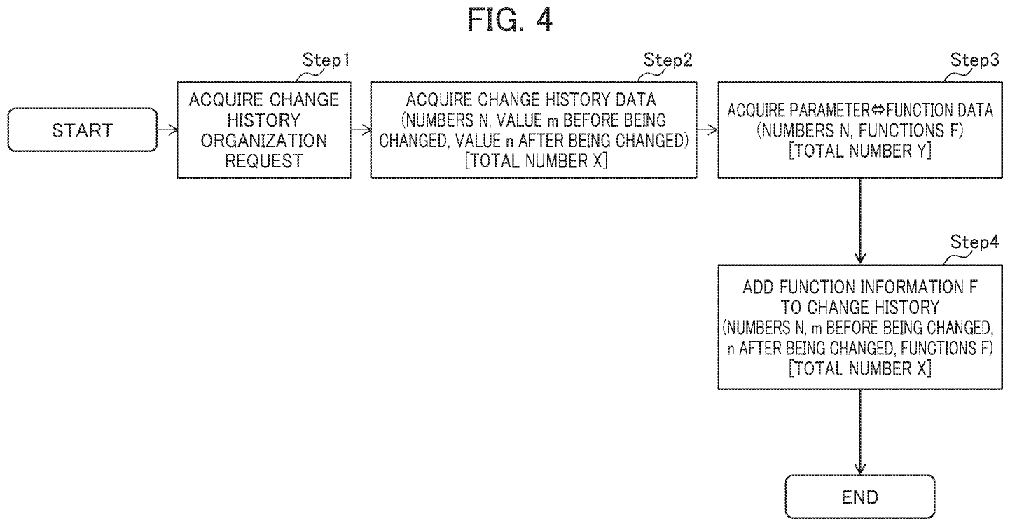

First, as shown in FIG. 4 (FIGS. 1, 2 and 3), when the change history organization request is provided based on a command operation by an operator or the like, the change history organization request acquisition unit 11 of the change history organization unit 2 receives this change history organization request (step 1). Furthermore, the change history acquisition unit 10 acquires the parameter change history data 8 from the storage unit 1 (step 2).

Then, the parameter attribute acquisition unit 12 acquires the parameter attribute data 7 from the storage unit 1. The attribute list generation unit 13 then checks and organizes parameter numbers N (a, b, c, x, y and z in FIG. 3), values of individual parameters before being changed and after being changed (m and n in FIG. 3) and functions F (Fun 1 and Fun 2 in FIG. 3) in the parameter change history data 8 acquired in the change history acquisition unit 10 and the parameter attribute data 7 acquired in the parameter attribute acquisition unit 12, and thereby generates an attribute list/change history list 15 (step 3 and step 4).

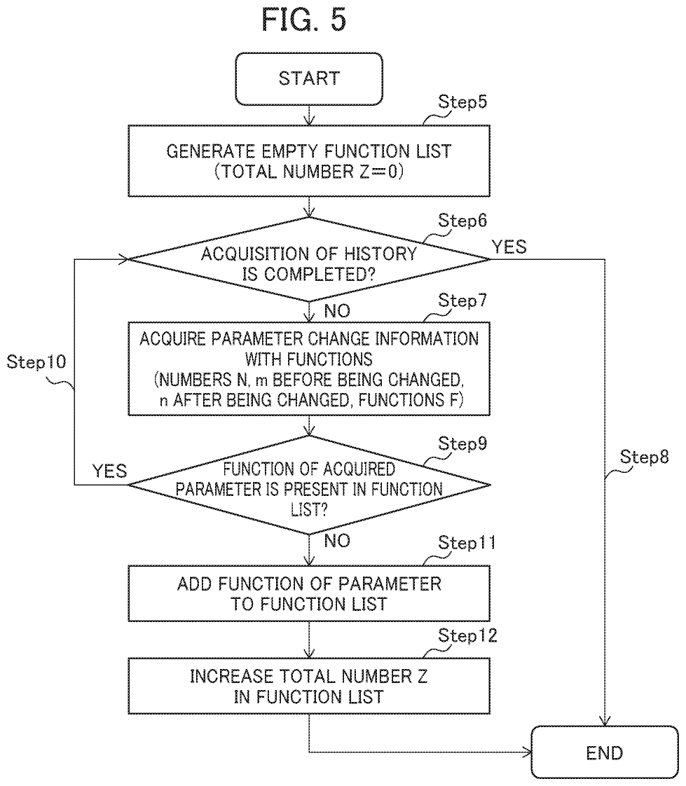

When the attribute list/change history list 15 is generated, as shown in FIG. 5 (FIGS. 1, 2 and 3), the attribute list generation unit 13 generates an empty function list (step 5). Here, the function list is a list which indicates only information on the functions (Fun 1 and Fun 2) such as a major classification of Fun 1 and its minor classifications of No. 1, No. 2, No. 3, . . . and a major classification of Fun 2 and its minor classifications of No. 1, No. 2, No. 3, . . . .

Then, whether or not the acquisition of the history is completed is checked (step 6) and when it is not completed, the parameter attribute acquisition unit 12 acquires parameter change information with functions (step 7). When the acquisition of the history is completed, is completed as it is (Step 8).

Then, when the acquisition of the history is not completed, the parameter change information with functions is acquired, and thereafter whether or not the function of the acquired parameter is present in the function list is checked (step 9). When the function of the acquired parameter is present in the function list, whether or not the acquisition of the history is completed is checked, and the operation described above is repeated (step 10).

On the other hand, when the function of the acquired parameter is not present in the function list, the function of the parameter is added to the function list (step 11). In this way, the total number Z in the function list is increased (step 12).

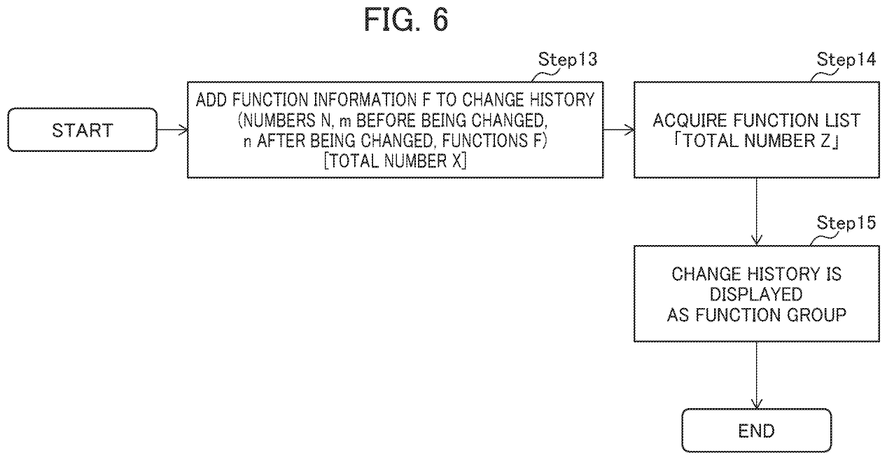

Then, as shown in FIG. 6 (FIGS. 1, 2 and 3), the function list in which function information F (numbers N, m before being changed, n after being changed and functions F) [total number X] is added to the change history, that is, the change history list 15 as shown in the diagram on the left side of FIG. 3 is acquired [total number Z] (step 13 and step 14).

Then, the change history attribute unit list generation unit 14 organizes the change history list 15 for each of the functions so as to generate the change history attribute unit list 16 as shown in the diagram on the left side of FIG. 3 (step 15), and the change history display unit 3 displays the change history attribute unit list 16.

Hence, in the control system A of the machine tool in the present embodiment, as described above, the change history attribute unit list 16 (chronological change history information for each of the attributes) in which the change history is organized for each of the attributes (functions) is displayed and thus when the operator sees the change history attribute unit list 16, the operator can easily check the change history of parameters which are changed a plurality of times, that is, the change history of the past parameters.

In the control system A of the machine tool in the present embodiment, since the change history for each of the attributes is displayed in the change history attribute unit list 16, it is possible to select target information (parameters) with the Undo/Redo target selection unit 4, and it is possible to return to the selected parameters with the parameter setting return processing unit 5. In this way, by use of the information of the change history attribute unit list 16, the parameters which are changed a plurality of times can be returned, in one stroke, to a previous setting. The changed parameters are categorized in the change history, and thus the cancellation of the change of parameters or the like can be performed for each function unit (attribute unit).

Hence, with the control system A of the machine tool in the present embodiment, it is possible to efficiently return the set state of parameters for CNC to a previous set state. In this way, it is possible to organize the change history arranged chronologically and to return, in one stroke, to desired parameters, and thus as compared with a conventional one, it is possible to significantly reduce the effort, the labor and the time of the operator when the setting of parameters for CNC is changed.

Although the embodiment of the control system of the machine tool according to the present invention is described above, the present invention is not limited to the embodiment described above, and can be modified as necessary without departing from the spirit thereof.

For example, although in the present embodiment, the function used as the attribute, and the change history attribute unit list 16 organized for each of the functions, the attribute may naturally be another attribute such as the mechanical system of the machine tool.

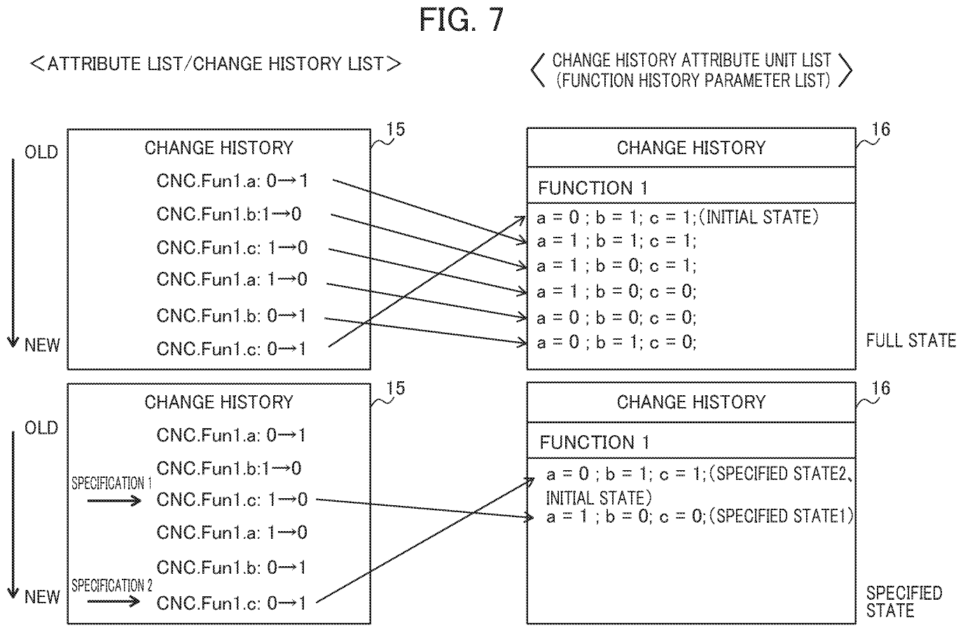

Here, when as shown in FIG. 7, in the change history list 15, a history in which one parameter is changed a plurality of times is present, a plurality of parameters having the same attribute (function) are treated as one set, and thus the parameters are preferably returned for each unit of the set state of parameters.

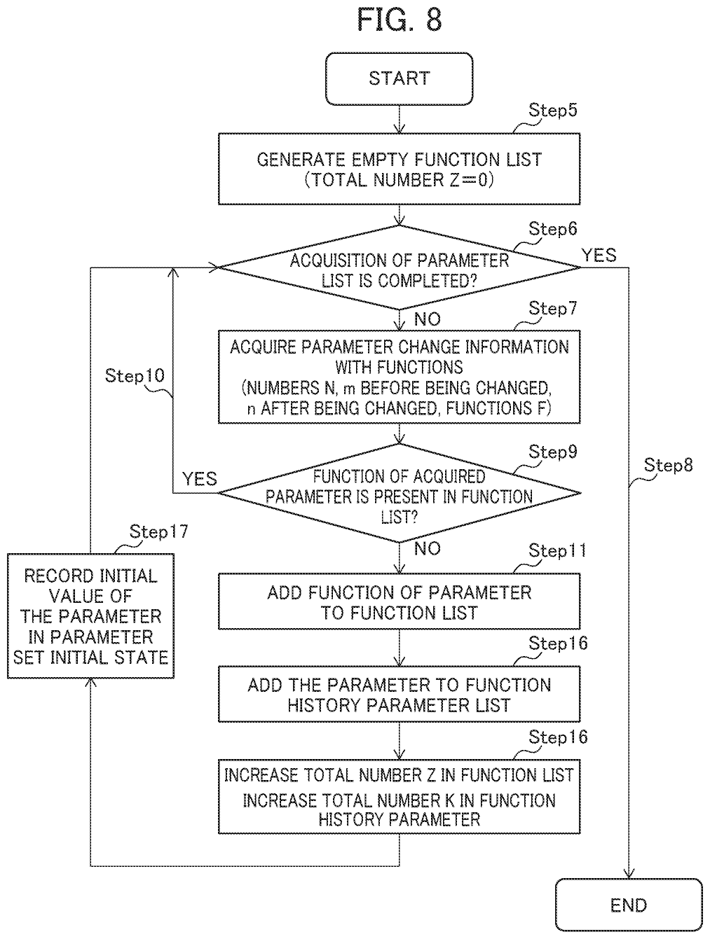

Specifically, when in the change history list 15, a history in which one parameter is changed a plurality of times is present, for example as shown in FIGS. 7 and 8 and as described above, whether or not the function of the parameter acquired in step 9 is present in the function list is checked, and when the function of the parameter is not present in the function list, in step 11, the function of the parameter is added to the function list.

Thereafter, the parameter is added to the change history attribute unit list (function history parameter list) 16, and the initial value of the parameter is recorded as a parameter set initial state (step 17).

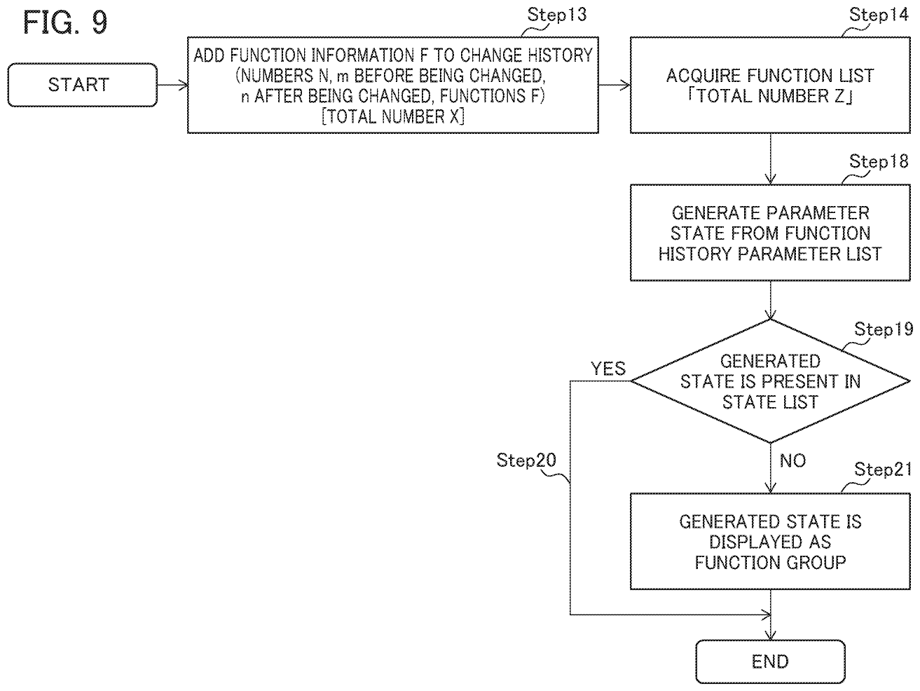

As shown in FIGS. 7 and 9, the function list in which the function information F (the numbers N, m before being changed, n after being changed and the functions F) [total number X] is added to the change history, that is, the change history list 15 as shown in the diagram on the left side of FIG. 7 is acquired [total number Z] (step 13 and step 14).

Thereafter, the Undo/Redo target selection unit 4 is used to select and specify the information of an arbitrary target in the change history list 15 (in the present embodiment, specification 1 is made when the parameters are changed at the first time and specification 2 is made when the parameters are changed at the second time), the change history attribute unit list (function history parameter list) 16 is set to the initial state and parameters in the state of specification 1 and in the state of specification 2 are organized as a set, with the result that a state list is generated (step 1).

Whether or not the generated state is present in the state list is checked (step 19), and when it is present therein, the process is completed without being processed (step 20) whereas when it is not present therein, the change history display unit 3 displays the generated state as a function group (step 21).

In this way, even when in the change history list 15, a history in which one parameter is changed a plurality of times is present, the information displayed in the change history display unit 3 is used so as to select the information (parameters) of the target with the Undo/Redo target selection unit 4, and thus it is possible to return to the parameters selected in the parameter setting return processing unit 5.

Hence, the information in the change history attribute unit list 16 is used, and thus it is possible to reliably return, in one stroke, parameters which are changed a plurality of times to a previous setting. The changed parameters are categorized in the change history, and thus the cancellation of the change of parameters or the like can be performed for each function unit (attribute unit).

### EXPLANATION OF REFERENCE NUMERALS

1 storage unit
2 change history organization unit
3 change history display unit
4 Undo/Redo target selection unit
5 parameter setting return processing unit
6 parameter display unit
7 parameter attribute data
8 parameter change history data
10 change history acquisition unit
11 change history organization request acquisition unit
12 parameter attribute acquisition unit
13 attribute list generation unit
14 change history attribute unit list generation unit
15 attribute list (change history list, function list)
16 change history attribute unit list (function history parameter list)
A control system of machine tool

What claimed is:

1. A control system or a machine tool which is automated by reflecting parameters with computerized numerical control, the control system comprising:
a storage unit which stores change history data of parameters and attribute data of the parameters; and
a change history organization unit which organizes, with the parameter change history data and the parameter attribute data, the parameters for each of change history attributes so as to generate a change history attribute unit list.

2. The control system of the machine tool according to claim 1, comprising: an Undo/Redo target selection unit which specifies arbitrary parameters in the change history attribute unit list; and
a parameter setting return processing unit which performs return processing for returning to the parameters specified in the Undo/Redo target selection unit.

3. The control system of the machine tool according to claim 1, comprising: a change history display unit which displays the change history attribute unit list.

4. The control system of the machine tool according to claim 2, comprising: a change history display unit which displays the change history attribute unit list.

5. The control system of the machine tool according to claim 1, wherein the change history organization unit includes:
a change history acquisition unit which acquires the parameter change history data from the storage unit;
a change history organization request acquisition unit which receives a change history organization request;
a parameter attribute acquisition unit which acquires the parameter attribute data from the storage unit;
an attribute list generation unit which uses the parameter change history data and the parameter attribute data so as to generate an attribute list of the parameters; and
a change history attribute unit list generation unit which organizes the attribute list for each of the change history attributes so as to generate the change history attribute unit list.

6. The control system of the machine tool according to claim 2, wherein the change history organization unit includes:
a change history acquisition unit which acquires the parameter change history data from the storage unit;
a change history organization request acquisition unit which receives a change history organization request;
a parameter attribute acquisition unit which acquires the parameter attribute data from the storage unit;
an attribute list generation unit which uses the parameter change history data and the parameter attribute data so as to generate an attribute list of parameters; and
a change history attribute unit list generation unit which organizes the attribute list for each of the change history attributes so as to generate the change history attribute unit list.

7. The control system of the machine tool according to claim 3, wherein the change history organization unit includes:
a change history acquisition unit which acquires the parameter change history data from the storage unit;
a change history organization request acquisition unit which receives a change history organization request;
a parameter attribute acquisition unit which acquires the parameter attribute data from the storage unit;
an attribute list generation unit which uses the parameter change history data and the parameter attribute data so as to generate an attribute list of parameters; and
a change history attribute unit list generation unit which organizes the attribute list for each of the change history attributes so as to generate the change history attribute unit list.

8. The control system of the machine tool according to claim 4, wherein the change history organization unit includes:
a change history acquisition unit which acquires the parameter change history data from the storage unit;
a change history organization request acquisition unit which receives a change history organization request;
a parameter attribute acquisition unit which acquires the parameter attribute data from the storage unit;
an attribute list generation unit which uses the parameter change history data and the parameter attribute data so as to generate an attribute list of parameters; and
a change history attribute unit list generation unit which organizes the attribute list for each of the change history attributes so as to generate the change history attribute unit list.

9. The control system of the machine tool according to claim 5, wherein when in the attribute list, a history in which one parameter is changed a plurality of times is present, a plurality of parameters having the same attribute are treated as one set such that the parameter setting return processing unit returns the parameters for each unit of a set state of the parameters.

10. The control system of the machine tool according to claim 6, wherein when in the attribute list, a history in which one parameter is changed a plurality of times is present, a plurality of parameters having the same attribute are treated as one set such that the parameter setting return processing unit returns the parameters for each unit of a set state of the parameters.

11. The control system of the machine tool according to claim 7, wherein when in the attribute list, a history in which one parameter is changed a plurality of times is present, a plurality of parameters having the same attribute are treated as one set such that the parameter setting return processing unit returns the parameters for each unit of a set state of the parameters.

12. The control system of the machine tool according to claim 8, wherein when in the attribute list, a history in which one parameter is changed a plurality of times is present, a plurality of parameters having the same attribute are treated as one set such that the parameter setting return processing unit returns the parameters for each unit of a set state of the parameters.
